(19) United States
(12) Patent Application Publication
(10) Pub. No.: US 2006/0260919 A1
(43) Pub. Date: Nov. 23, 2006

(54) Methods and apparatus for filling a microswitch with liquid metal

(76) Inventors: Marco Aimi, Saratoga Springs, NY (US); Timothy Beerling, San Francisco, CA (US); Kevin Killeen, Palo Alto, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/130,846

(22) Filed: May 17, 2005

(51) Int. Cl. H01H 35/34; H01H 11/00

(52) U.S. Cl. 200/83 F; 200/81 R; 29/622

(57) ABSTRACT

Enclosed (or at least substantially enclosed) microswitch cavities can be constructed with suitable channels, and in some instances vents, to allow for the transport of fluidic microswitch components to the cavities. This generally allows for fluid transport to cavities that are largely completed. Various techniques, including formation of pressure gradients and electrowetting, can be used to transport fluid along the channels. Additionally, structures and techniques for providing fluid to multiple microswitches and for providing fluid in desired amounts to microswitches are disclosed.

### BACKGROUND

Since the introduction of micromachining technology and microelectromechanical systems (MEMS) in 1980s, many types of mechanical actuation methods have been explored. Numerous different types of micromechanical switches (microswitches) have been developed using different actuation methods and design techniques. Many microswitch designs use solid-to-solid contact switches that possess some of the same problems that macroscale mechanical switches possess, such as wear of switch contacts and signal bounce.

In order to address solid-to-solid contact reliability problems, liquid metal (e.g., mercury, gallium alloys, indium alloys, and the like) droplets have been used as switching contacts in a variety of MEMS switch devices. Such devices possess a variety of advantages over solid-to-solid contact MEMS switch devices. They are free, or at least substantially free of mechanical wear problems associated with solid-to-solid contact switches. Vibrations encountered by the switch will generally dampen out quickly, particularly with smaller liquid metal droplets. Vibrations on the surface of liquid metal droplets generally do not cause signal bounce as long as electrode contacts remain wetted. Moreover, no external force is usually needed to keep liquid metal switch elements in contact with corresponding switch parts. Thus, such devices are said to be “naturally bi-stable.” Liquid metal microswitches also has a contact resistance that is repeatable over numerous switch cycles. Like MEMs switches with solid parts, liquid metal MEMS switches can also have very special advantages over transistor devices. For example, electromechanical devices are generally much less sensitive to charge disrupting radiation, and are therefore preferred for military and aerospace applications. Electromechanical devices including liquid droplet microswitches, also provide improved linearity and reduced “on” resistance as compared to semiconductor devices.

Regardless of the precise liquid metal microswitch architecture used, the proper amount (usually a very small amount on the order of tens of micrograms) of liquid metal has to be placed in the switch cavity. Filling microswitches with liquid metal can be a difficult task. In one technique, liquid metal is electroplated on a specially formed receiving surface (e.g., mercury electroplated on an iridium dot). Electroplating typically uses an electrolyte that may react with, or is otherwise incompatible with, the materials typically used to fabricate MEMS structures. In another technique, liquid metal vapor is deposited using selective condensation on specialized nucleation sites (e.g., mercury vapor on gold nucleation sites). In still other techniques, liquid metal is dispensed through nozzles onto a surface. Most of these techniques require the liquid metal to be deposited into an open switch cavity or onto an exposed surface, and then a cover plate or cavity is bonded to the portion of the switch on which the droplet was formed.

These methods allow for the controlled dispensing of liquid metal, but require the surface/cavity to be coved in later assembly steps that typically require elevated temperatures for bonding. Some liquid metals are susceptible to elevated temperatures due to evaporation, oxidation, and the increased solubility of surrounding metallic electrodes into the liquid metal. Bonding can also require a reduced base pressure to control the environment in the switch cavity. Some liquid metals have high vapor pressures and cannot be placed in a vacuum without rapidly evaporating. If this happens, the amount of liquid metal in the device will be reduced, affecting operation of the switch and potentially contaminating the vacuum system. Additionally, transporting a wafer containing multiple devices with the dispensed liquid metal can be problematic because of the tendency for the liquid metal to roll around on a free surface. If the liquid metal is dispensed onto a surface that has a large contact angle and low contact angle hysteresis, there is little to prevent the droplet from shifting position if the wafer is bumped during transport. If this does occur, the bonded cavity may not be properly aligned with the liquid metal droplet, causing the potential failure of the device.

### SUMMARY

In accordance with the invention, enclosed (or at least substantially enclosed) microswitch cavities can be constructed with suitable channels, and in some instances vents, to allow for the transport of fluidic microswitch components to the cavities. This generally allows for fluid transport to cavities that are largely completed. Various techniques, including formation of pressure gradients and electrowetting, can be used to transport fluid along the channels. Additionally, structures and techniques for providing fluid to multiple microswitches and for providing fluid in desired amounts to microswitches are disclosed.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways, and such changes and modifications may be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

FIGS. 1A-1C illustrate several different embodiments in accordance with the invention of microswitch cavities and corresponding features used to deposit liquid metal into the microswitch.

FIG. 2 illustrates an example of the microswitch cavity of FIG. 1C, including deposited liquid metal in the microswitch cavity and a plugged fluid channel in accordance with the invention.

FIG. 3 illustrates a device and technique for depositing liquid metal in a microswitch cavity such as that illustrated in FIG. 1C in accordance with the invention.

FIGS. 4A4B illustrate examples of components used to accomplish electrowetting in microswitches and associated fluid channels and cavities in accordance with the invention.

FIG. 5 illustrates a schematic diagram of a device used to load one or more microswitch cavities with liquid metal in accordance with the invention.

### DETAILED DESCRIPTION

The following sets forth a detailed description of the best contemplated mode for carrying out the invention. The description is intended to be illustrative of the invention and should not be taken to be limiting.

Throughout this application, reference will be made to various MEMS device fabrication processes and techniques which will be well known to those having ordinary skill in the art. Many of these processes and techniques are borrowed from semiconductor device fabrication technology, e.g., photolithography techniques, thin film deposition and growth techniques, etching processes, etc., while other techniques have been developed and/or refined specifically for MEMS applications. Additionally, the presently described devices and techniques focus on the use of liquid metal in microswitches. Examples of suitable liquid metals include mercury, gallium alloys, and indium alloys. Other examples of suitable liquid metals, e.g., with acceptable conductivity, stability, and surface tension properties, will be known to those skilled in the art. In still other examples, the presently described devices and techniques can be used to deliver other electrically conducting liquids to microswitches.

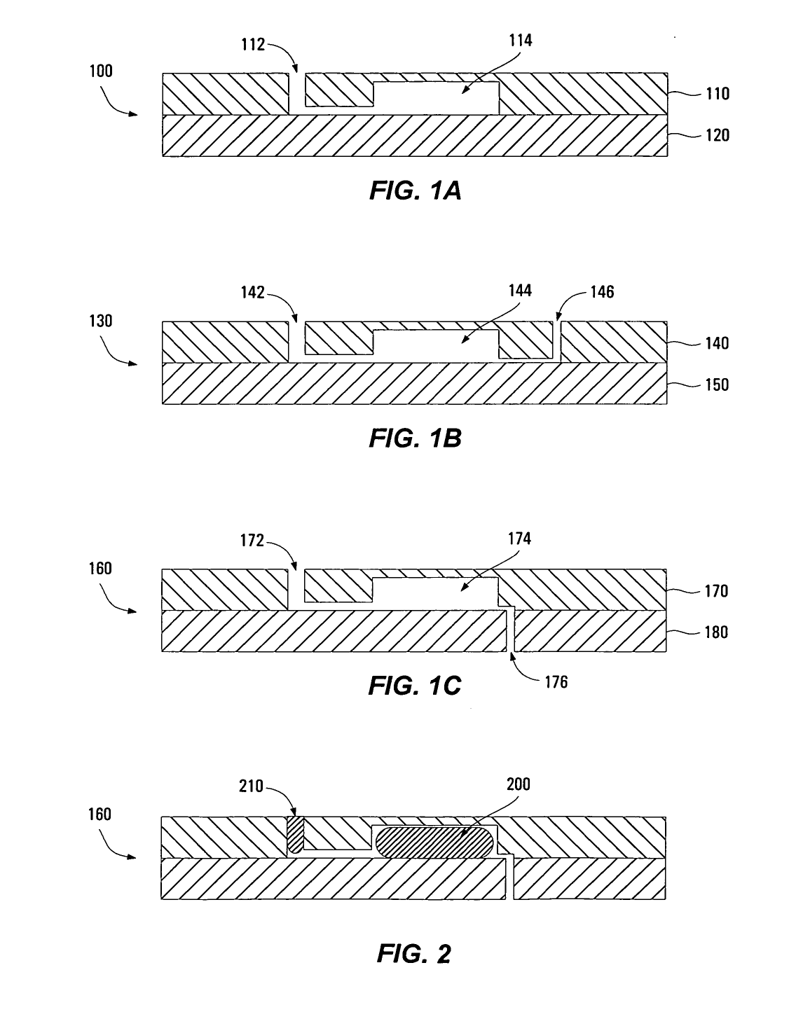

FIGS. 1A-1C illustrate several different embodiments of microswitch cavities and corresponding features used to deposit liquid metal into the microswitch. In each of the examples illustrated, the microswitch cavity is designed to be filled with liquid metal after the cavity is formed. In most cases cavity formation is not complete until two separate structures are bonded together. For example, various electrodes, heaters, insulators, cavity portions, and other circuit/MEMS devices can be fabricated on a first semiconductor wafer (e.g., silicon) using conventional semiconductor processing techniques. The remainder of the cavity structure (e.g., a cavity roof, lid, or enclosure) can be fabricated on a second wafer, and the two wafers aligned and bonded to form the complete structure. Numerous well known wafer bonding techniques, such as anodic bonding, fusion bonding, glass frit bonding, adhesive bonding, eutectic bonding, microwave bonding, thermocompression bonding, and solder bonding, can be used. Although the examples in accordance with the invention emphasize devices formed from two separate, bonded layers, sufficiently enclosed microswitch cavities can be fabricated on a single wafer, and thus the presently described devices and techniques have equal applicability.

As shown in FIG. 1A, device 100 is formed from two separate material layers 110 and 120. In this case, each of material layers 110 and 120 are separate wafers (or portions thereof) that have been bonded together. For simplicity of illustration, numerous structures and features, such as various electrodes, heaters, diaphragms, etc. used in the actuation of a liquid metal droplet microswitch, have been omitted from the figure. Additionally, the figure does not show the liquid metal itself. Microswitch cavity 114 is shown in cross-section. The cross section shown is illustrative of either the cavity's width (in the case of a microswitch where liquid metal droplet motion would be in/out of the plane of the figure) or its length (where liquid metal droplet motion would be in the plane of the figure). Fluidic channel 112 provides a path along which liquid metal can be introduced and transported to microswitch cavity 114. These channels or conduits are typically surrounded on all sides by walls, as opposed to having an open or exposed side. By integrating fluidic channel 112 into device 100, and into the switch architecture generally, liquid metal is allowed to flow from an external liquid metal reservoir into the microswitch cavity. This configuration allows the microswitch cavity to be filled using embedded channels and eliminates the need for bonding around deposited liquid metal.

Microswitch cavity 114 includes a single fluidic channel, and so the process of depositing liquid metal into the cavity should be designed to account for the absence of a separate vent associated with the cavity. In one example, cavity 114 and channel 112 are be pumped down in a vacuum, thereby removing some or all of the gas in the switching cavity. The device as a whole (e.g., the bonded wafers) or a closed portion of the device (e.g., as defined by a manifold surrounding at least the inlet to channel 112) would then be subjected to a liquid metal bath also under vacuum. The pressure of the liquid metal bath is then raised (e.g., brought back to atmospheric pressure) to force the liquid metal into cavity 114 as a result of the pressure gradient developed along the channel. This pressure gradient forces the liquid metal into the cavity without the need of a vent. In other examples, liquid metal is deposited in such a manner that channel 112 acts as both a conduit into and a vent for cavity 114. In still other embodiments, thermal gradients or electrowetting techniques can be used to move liquid metal along channel 112 and into cavity 114.

FIGS. 1B and 1C illustrate additional embodiments where a vent from the microswitch cavity is also provided. As shown in FIG. 1B, device 130 is formed from two separate material layers 140 and 150 that have been appropriately patterned and bonded together. In this example in accordance with the invention, microswitch cavity 144 is coupled to fluidic channel 142 for providing a path along which liquid metal can be introduced and transported to microswitch cavity 144. Microswitch cavity 144 is also coupled to vent 146, to provide an appropriate pressure gradient during the process of filling microswitch cavity 144 with an appropriate amount of liquid metal. Vent 146 can be referred to as a “front side” vent because it is open two the same side of the device as fluidic channel 142. Vent 146 is typically smaller (at least in cross-sectional area) than fluidic channel 142 so as to decrease the chance that liquid metal can escape from vent 146 either during the process of filling the microcavity, or in subsequent operation. In many embodiments, associated surfaces are also non-wetting to inhibit fluid flow. Thus, because of the reduced cross-sectional area at the point where vent 146 meets cavity 144, significant pressure would normally be required to force the cavity's liquid metal contents into and through vent 146. Nevertheless, even relatively small vents can provide an adequate pressure gradient for the cavity filling process, as will be understood by those having ordinary skill in the art.

In general, the process of depositing liquid metal into cavity 144 takes advantage of a pressure gradient provided from fluidic channel 142, through cavity 144, and out vent 146. For example, a nozzle, manifold, or other device can provide a seal around the mouth of fluidic channel 142. Liquid metal is provided through the nozzle, etc. at a pressure higher than the pressure inside microswitch cavity 144. The pressure inside cavity 144 is lower than the liquid metal injection pressure because vent 146 couples microswitch cavity 144 to a lower pressure, e.g., the ambient pressure outside the device, or a low pressure source provided at the mouth of vent 146. The pressure gradient forces liquid metal through fluidic channel 142 and into microswitch cavity 144. Pressures are selected so that the injection pressure is not large enough (or at least not significantly large enough) to overcome capillary repulsive forces associated with vent 146, e.g., at or near the junction of microswitch cavity 144 and vent 146. Thus, liquid metal does not flow into vent 146 during the filling process. In some embodiments, e.g., where relatively high injection pressures are used, liquid metal can be allowed to flow through vent 146. At that point, liquid metal flow in vent 146 or outside of vent 146 can be used to determine a stopping point in the filling process. In such embodiments, returning the system to ambient pressure, or quickly providing modest backpressure along vent 146 is adequate to complete the process.

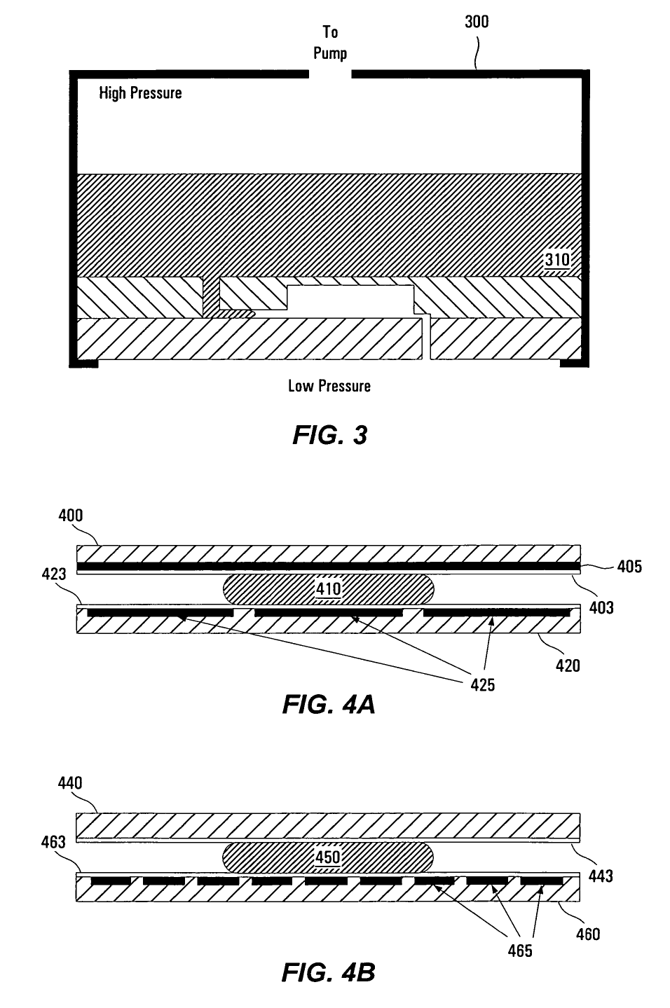

FIG. 1C illustrates a similar, but alternate embodiment in accordance with the invention. Device 160 is formed from two separate material layers 170 and 180 that have been appropriately patterned and bonded together. Microswitch cavity 174 is coupled to fluidic channel 172 for providing a path along which liquid metal can be introduced and transported to microswitch cavity 174. Microswitch cavity 174 is also coupled to vent 176 (in this case a “back side” vent), to provide a pressure gradient during the process of filling microswitch cavity 174 with an appropriate amount of liquid metal. In this example, both material layers 170 and 180 include features that together form vent 176. The process of depositing liquid metal into microswitch cavity 174 also takes advantage of pressure gradients developed along the path from fluidic channel 172, to microswitch cavity 174, and out through vent 176. Thus, processes similar to those described above for device 130 can be used to provide liquid metal to microswitch cavity 174. The presence of the mouths fluidic channel 172 and vent 176 on opposite sides of device 160 can provide some advantages in the filling process, as will be discussed below in the context of FIG. 3.

It should be noted that in most embodiments in accordance with the invention, the interior surfaces of the variously described fluidic channels, microswitch cavities, and vents, are typically designed to be non-wetting, at least with respect to the liquid metal used in the device. Such features help establish the desired capillary forces (generally repulsive) and contact angle of the liquid metal droplet used in the microswitch. Non-wetting surfaces help prevent subsequent flow (e.g., via wicking or capillary effects) of the liquid metal out of the microswitch cavity, thereby providing long-term stability of the overall device. When fabricated using traditional semiconductor fabrication processes and techniques, growth of thin layer of SiO₂ on the walls of device features etched from silicon provides a good example of an insulating and non-wetting surface material for liquid metals. At some locations along the fluid path, and indeed within the microswitch cavity itself, it may nevertheless be desirable to have localized areas that are wettable so as to enhance movement of liquid metal at particular times, e.g., during liquid metal filling or during microswitch operation. Consequently, certain locations (not shown) can include surface coatings that are wettable, and/or other device features (e.g., electrodes used for electrowetting) to enhance wettability.

The geometries of the fluidic channels and vents illustrated can also vary according to a number of parameters. These paths can have a variety of different lengths, cross-sectional shapes, cross-sectional areas, etc. The paths can generally be coupled to corresponding microswitch cavities at any surface of the cavity as desired. Path can be straight (e.g., through holes or vias), have one or more turns (at various angles), or even be curved or contoured. The paths shown in FIGS. 1A-1C are generally co-planar, but that need not be the case. Thus, a vent can be in one plane, while a fluidic channel is in another. Depending on the shape, bending, and curving of a given path, it need not be in (or at least have its centerline in) a single plane. Although only one each of a fluidic channel and a vent is illustrated for each microswitch cavity, multiple instances of either or both can be implemented for a particular microswitch cavity as desired. In short, those skilled in the art will readily recognize numerous variations on the shape, size, and location of the vents and fluidic channels described herein.

In some embodiments in accordance with the invention, it may be necessary or desirable to fill certain pathways (or entrances thereto) with a plug material to prevent degradation of the device. FIG. 2 illustrates an example of the microswitch cavity of Figure IC, including deposited liquid metal (200) in the microswitch cavity and a plug (210) inserted at the mouth of fluid channel 172. Plug 210 helps to prevent evaporation and contamination of the liquid metal in microswitch cavity 174. In some embodiments, the same liquid metal used for deposited liquid metal 200 can be used for plug 210, alone or alloyed with another material. For example, the geometry of the channel mouth and the properties of the liquid metal material can be adequate to keep plug 210 in place and provide adequate longevity for the plug. In other embodiments, semi-solid or very high viscosity materials (e.g., waxes, glasses, etc.), solders, or bonded capping layers can also be used. In still other embodiments, material can be deposited (e.g., via chemical vapor deposition (CVD), physical vapor deposition (PVD), and atomic layer deposition (ALD), or other deposition techniques) to plug the channel. As shown, vent 176 is not plugged because its geometry is such that evaporation, contamination, or other degradation of the liquid metal in microswitch cavity 174 is not likely, or at least not significant enough to warrant a plug. In other embodiments in accordance with the invention, vents can also be plugged.

FIG. 3 illustrates a device and technique for depositing liquid metal in a microswitch cavity such as that illustrated in FIG. 1C. As noted above, microswitch cavity 174 is filled by developing a pressure gradient along the path into and out of the cavity. Pressurized liquid metal reservoir 300 is configured to provide a sufficiently tight seal around device 170, with one side of the device facing inward (toward the liquid metal reservoir) and one side of the device facing outward. Although schematically illustrated at the device level, pressurized liquid metal reservoir 300 is typically designed to operate on a entire wafer (or bonded wafer pair) of devices simultaneously. The devices are oriented such that the mouth fluidic

channel 172 is in contact with the high pressure liquid metal reservoir, and the mouth of vent 176 is exposed to a low pressure region, e.g., ambient pressure or a vacuum source. The high pressure in liquid metal reservoir 300 is typically developed using a suitable fluid pump (not shown). In other examples, a mechanical diaphragm, a piston, or pneumatic pressure can be used to push the liquid metal against the device, thereby developing the high pressure.

As shown in FIG. 3, high pressure liquid metal reservoir 300 is designed to make contact with and secure the wafer on the vent side of the wafer such that the high pressure liquid metal forces the wafer against a retaining ring or edge of device 300. In alternate embodiments in accordance with the invention, high pressure liquid metal reservoir 300 can include a gasket, seal, or manifold that mates with the front side (i.e., the fluidic channel side) of the wafer and forms an appropriate seal. Numerous other variations of the basic configuration of device 300 will be known to those having ordinary skill in the art. As noted above, the filling process is determined to be complete using a variety of different techniques including, but not limited to, detecting liquid metal emerging on the vent side, detecting the presence of liquid metal in the vent, measuring reservoir parameters such as volume or pressure, detecting liquid metal presence in the microswitch cavity, using an amount of liquid metal known to be adequate for filling the microswitch cavity, self-limiting processes such as those described below, and the like.

In addition to relying on pressure gradients, various aspect of delivering liquid metal to a microswitch cavity can be performed and/or enhanced through the use of electrowetting. As an illustration of the electrowetting effect, placement of a liquid droplet on a non-wetting surface causes the droplet to maintain a contact angle greater than 90°. If the liquid droplet is polarizable and/or at least slightly electrically conductive, an electrical potential applied between the droplet and an insulated electrode underneath the droplet, reduces the droplet's contact angle with the surface on which it rests. Reducing the droplet's contact angle improves wetting with respect to the surface. The improved wetting occurs because the effective solid-liquid interfacial energy is lowered as a result of the electrostatic energy stored in the capacitor formed by the droplet/insulator/electrode system. The effect depends on a number of factors including applied voltage (and thus electrode configuration), insulator parameters (e.g., thickness and dielectric constant), and liquid droplet properties. However, with proper selection of system properties, relatively large and reversible contact angle changes are achieved.

In addition to affecting the local wettability where the droplet rests, application of an electric field (e.g., on one side of the droplet) can cause changes in contact angle leading to capillary pressure gradients that drive bulk flow of the droplet. Numerous electrowetting-based microactuators have been demonstrated using this effect. FIG. 4A illustrates a cross sectional view of a device configured to move a liquid metal droplet using the electrowetting effect. Liquid metal droplet 410 is sandwiched between two material layers 400 and 420, typically formed using semiconductor/MEMS processing compatible materials such as silicon substrates. The surface of each of material layers 400 and 420 is coated with a suitable dielectric material layer (e.g., SiO₂) 403, 423, so as to provide adequate electrical insulation, dielectric properties, and non-wetting conditions. Each material layer also includes one or more electrodes 405 and 425, insulated from liquid metal droplet 410 and used to drive the electrowetting effect. In this example, the upper material layer includes a single continuous ground electrode 405, while the lower material layer has multiple independently addressable electrodes 425 for controlling movement of the liquid metal droplet. In general, electrode size and liquid metal droplet volume are selected so that a droplet centered on one of electrodes 425 slightly overlaps adjacent electrodes. In still other examples, multiple separate ground electrodes are used.

When both sets of electrodes (405 and 425) are grounded, no charged capacitive paths are formed among the electrodes/insulators/droplet. Consequently, the energy of the system is generally independent of the position of liquid metal droplet 410. When an adequate voltage is applied between ground electrode 405 and one of electrodes 425 that overlaps with liquid metal droplet 410, the resulting surface energy gradient causes the droplet to move so as to align itself with the charged electrode. Successive energizing of electrodes 425 allows liquid metal droplet 410 to be translated in the plane of the figure. Electrodes not specifically maintained at ground or an applied voltage are typically left in a high impedance state (e.g., left to float). Thus, inclusion of various electrowetting electrodes and insulating fluid channel surfaces can provide another (or at least a complimentary) technique for transporting liquid metal into a microswitch cavity. Various different patterns of voltage activation or electrode arrangement can similarly accomplish a variety of liquid metal manipulation operations, such as basic transport, splitting, and merging.

FIG. 4B illustrates another configuration that can be used to accomplish similar liquid metal transport via electrowetting. As before, the device includes a liquid metal droplet 450 sandwiched between two material layers 440 and 460. The surface of each of material layers 440 and 460 is coated with a suitable dielectric material layer 443, 463, so as to provide adequate electrical insulation, dielectric properties, and non-wetting conditions. Material layer 440 does not include a ground electrode. Instead, material layer 460 includes a series of electrodes 465 that are used to drive liquid metal droplet 450. In some embodiments in accordance with the invention, certain electrodes can be grounded while others are maintained at a higher voltage. In other embodiments in accordance with the invention, electrodes 465 are alternately charged without the use of a ground electrode. This technique generally requires the control electrode pitch to be sufficiently smaller than the liquid metal droplet size.

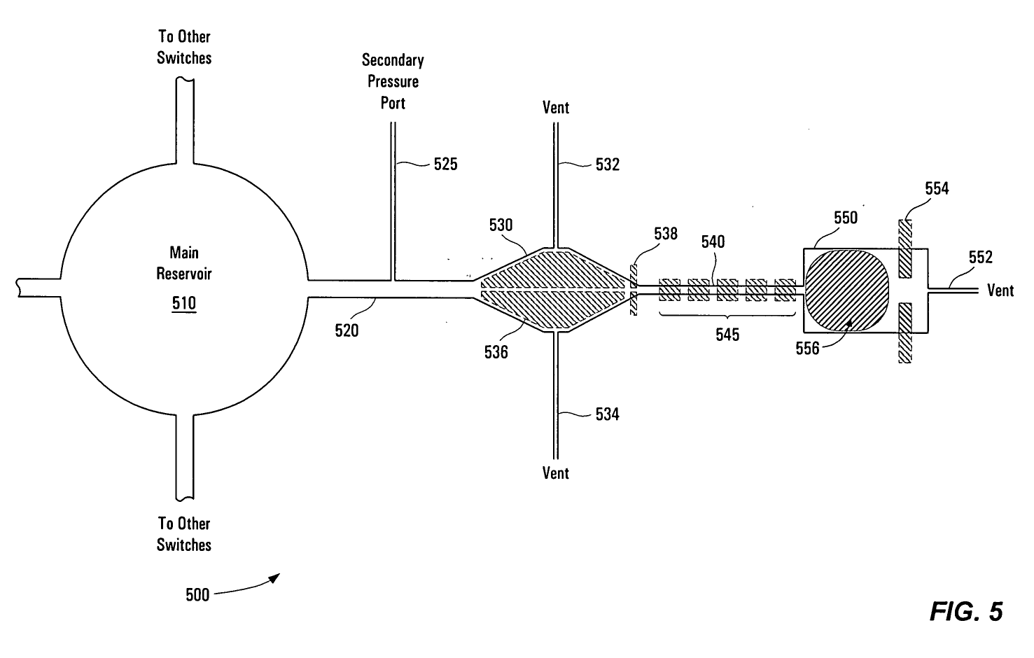

Numerous other electrode arrangements can be implemented. For example, ground electrodes can be insulated from, or in direct electrical contact with, the liquid metal droplet. Ground electrodes can be placed in the same material layer as the control electrodes. Moreover, both material layers can contain control electrodes, e.g., facing pairs of electrodes with opposite polarity when energized. Any of the electrowetting devices and techniques can be used in conjunction with the devices/techniques illustrated in FIGS. 1A-3, or as described below, those illustrated in FIG. 5.

In a typical manufacturing environment, multiple microswitch devices will be fabricated on a single wafer or bonded wafer pair. Since numerous microswitch cavities will need to be filled with liquid metal, devices and techniques that simplify the process of filling numerous cavities will be very useful. FIG. 5 illustrates a schematic diagram of a device used to load one or more microswitch cavities with liquid metal. Some or all of the previously described liquid metal transportation techniques can be used individually, or in combination, as part of filling system 500 shown in FIG. 5.

Filing system 500 is shown from above and is defined in part by numerous walls, channels, cavities, and other surfaces typically formed (e.g., etched) from a substrate material (or a combination of substrates) such as silicon or borosilicate glass. Filing system 500 includes main reservoir used to hold a large amount of liquid metal, typically enough for the number of microswitch cavities it is designed to service, with perhaps some reserve. Main reservoir 510 is configured to be loaded using more conventional techniques such as nozzle or needle injection, and will typically include one or more ports (not shown) to accommodate delivery of liquid metal. Although shown having curved side walls, reservoir 510 (and indeed any of the channels, reservoirs, or cavities illustrated) can be implemented using any desired shape or configuration. Main reservoir 510 can also be connected to via a number of channels, capillaries or conduits to other microswitches, thereby servicing multiple microswitches and simplifying the overall process of delivering liquid metal to the microswitches.

FIG. 5 illustrates one wing of the filling system that is used to provide liquid metal to microswitch cavity 550. The channels from main reservoir 510, such as channel 520 are generally non-wetting so that no fluid enters the channel without an applied force. As noted above, numerous techniques can be used to render the surfaces of the channels non-wetting for liquid metals, a typical one being the formation of an SiO₂ layer along the walls of the channels. Additionally, the size or shape of the channel opening at main reservoir 510 can be selected to encourage liquid metal to remain on one side or the other based on surface tension effects and sidewall wetting.

Channel 520 is coupled to a secondary reservoir 530, typically sized to contain the correct volume of liquid metal for the microswitch. Because of the size of the microswitch cavity, tolerances for the delivered liquid metal droplet, and potentially the number of cavities to be filled, controlling the amount of liquid delivered to the cavity can be very difficult, and sizing secondary reservoir 530 appropriately is an effective way to control delivered liquid volume. Secondary reservoir 530 can generally take any shape, and in some embodiments can be designed to have a volume greater than the volume desired for the liquid metal droplet used in microswitch cavity 550. In this example in accordance with the invention, the shape of secondary reservoir 530 is designed to facilitate fluid flow, and accommodate the changes in channel size between channel 520 and channel 540. Secondary reservoir 530 can be filled by applying a sufficient pressure differential from main reservoir 510 (e.g., via its filing port or another port, not shown) to one or more secondary reservoir vents 532, 534, and 552 to drive fluid into through channel 520. This process can be assisted by using electrowetting techniques, e.g., one or more electrodes (not shown) located along channel 520 to make the channel temporarily wettable and/or to move liquid metal as described above. In still other embodiments, liquid metal is moved primarily via the use of electrowetting techniques. Similarly, the process can be assisted via electrowetting in a portion of main reservoir 510 or in secondary reservoir 530, e.g., using electrodes 536. As shown, such electrodes are typically insulated from any liquid metal present in the reservoir by, for example, the SiO₂ dielectric layer.

The sizes of secondary pressure port 525, channel 540, and vents 532 and 534, are generally designed so that a pressure differential adequate to force liquid metal out of main reservoir 510, along channel 520, and into secondary reservoir 530, is not sufficient to allow fluid to enter the other channels. So, for example, the mouths of channel 520 are wider than those for channel 540, which in turn are wider than the mouths of vents 532, 534, and 552. For fluid in a capillary, the pressure needed to drive the fluid is roughly proportional to the surface tension of the fluid and roughly inversely proportional to the dimensions of the capillary. Thus, narrower channels generally require higher pressures for the same fluid when channel surfaces are non-wetting. If the shape of the junction between a reservoir and a channel is properly designed, the fluid will snap at that point when pressure is removed, and the fluid will remain contained. When a filling pressure is removed, electrowetting forces removed, or some combination of the two, the liquid metal in channel 520 will recede back into main reservoir 510, but the liquid metal in secondary reservoir 530 will remain.

In some embodiments in accordance with the invention, secondary reservoir 530 can also include contact electrodes 538 used to determine when liquid metal has reached the far end of the reservoir. Portions of electrodes 538 are exposed on one or more surfaces of reservoir 530, or perhaps channel 540 just outside reservoir 530, so that the presence of liquid metal completes a circuit between the electrodes. A signal from this circuit can be used to determine when reservoir 530 is full, and thus when liquid metal driving forces can be removed. In other embodiments in accordance with the invention, removal of the driving force(s) can be determined based on timing, volume changes in main reservoir 510, capacitive effects, and the like.

Once secondary reservoir 530 is loaded with the proper amount of liquid metal and channel 520 is emptied, the process of loading microswitch cavity 550 can commence. To move liquid metal from secondary reservoir 530 to microswitch cavity 550, an even higher pressure is needed, and/or larger changes in contact angle through electrowetting are used. The pressure difference can be applied across secondary pressure port 525 and vent 552. Such a pressure gradient draws all the fluid from secondary reservoir 530 to microswitch cavity 550, without any interference from main reservoir 510. Again, the geometries are selected such that, during normal operation, liquid metal droplet 556 in microswitch cavity 550 will not go into vent 552 (or vents 532 and 534), or back into channel 540. Where electrowetting is used, a series of insulated electrodes 545 can be used to move liquid metal along channel 540 using electrowetting forces. This can be used instead of or in addition to one or both of pressure gradients and other electrowetting activity, such as using electrowetting electrodes in switch cavity 550 or elsewhere (not shown). Note that for clarity of illustration, various contact traces and control circuitry for the illustrated electrodes (include electrodes 554 used as part of the microswitch) have not been shown. Such details are well within the knowledge of those having ordinary skill in the art.

Numerous other variation in size, shape, pressure differential application, electrode configuration, etc. will be known to those skilled in the art. Moreover, a variety of different implementations my be fabrication process dependent. For example, it may be desirable to fabricate many or all of the electrodes used and their control circuitry in a single wafer having a relatively planar surface that will ultimately define one surface of the various reservoirs, cavities, channels, vents, etc. A second wafer can be processed (e.g., using various etching techniques) to define the remaining surfaces of the reservoirs, cavities, channels, vents, etc. When the two wafers are bonded together, the completed devices are formed. Such a technique can also be useful in accommodating minor process errors or variations. For example, the aforementioned first wafer can be fabricated so as to accommodate small amounts of wafer misalignment when bonded to the second wafer. Additionally, fabricating the majority of the fluid surfaces on a single wafer or in a single process step will generally make the final device less susceptible to variations in etch steps, and the like.

The devices and techniques described in the present application can be used with numerous conducting liquids, and not just liquid metals. Moreover, the devices and techniques described in the present application can be used to provide fluid to various different types of microswitches (thermally actuated, pressure actuated, electrically actuated, etc.) and even other devices that might not be properly characterized as microswitches.

Those skilled in the art will readily recognize that a variety of different types of optical components and materials can be used in place of the components and materials discussed above. Moreover, the description of the invention set forth herein is illustrative and is not intended to limit the scope of the invention as set forth in the following claims. Variations and modifications of the embodiments disclosed herein may be made based on the description set forth herein, without departing from the scope and spirit of the invention as set forth in the following claims.

What is claimed is:

1. An apparatus comprising:
a device substrate;
a substantially enclosed microswitch cavity at least partially defined by a portion of the device substrate; and
a channel coupled to the substantially enclosed microswitch cavity and configured to deliver a fluidic component of a microswitch to the substantially enclosed microswitch cavity.

2. The apparatus of claim 1 further comprising:
a vent coupled to the substantially enclosed microswitch cavity, wherein the vent includes a first vent opening where the vent is coupled to the substantially enclosed microswitch cavity and a second vent opening at an opposite end of the vent, wherein the channel includes a first channel opening where the channel is coupled to the substantially enclosed microswitch cavity and a second channel opening at an opposite end of the channel, and wherein the second channel opening and the second vent opening are on one of a same side of the device substrate and opposite sides of the device substrate.

3. The apparatus of claim 2 wherein the first vent opening is smaller than the first channel opening.

4. The apparatus of claim 1 further comprising a second device substrate coupled to the device substrate, wherein a portion of the second device substrate further defines the substantially enclosed microswitch cavity.

5. The apparatus of claim 1 wherein the fluidic component of the microswitch further comprises at least one of an electrically conductive fluid, a liquid metal, and a liquid metal alloy.

6. The apparatus of claim 1 further comprising:
a fluid reservoir coupled to the channel and sized to hold at least a volume of fluid sufficient for the fluidic component of the microswitch.

7. The apparatus of claim 6 further comprising:
at least one electrode at least partially exposed to a surface of the fluid reservoir, wherein the at least one electrode is positioned to detect the presence of fluid in the reservoir.

8. The apparatus of claim 1 wherein at least one surface of at least one of the substantially enclosed microswitch cavity and the channel further comprises a dielectric layer.

9. The apparatus of claim 1 further comprising:
at least one electrode positioned in proximity to at least one of the substantially enclosed microswitch cavity and the channel, wherein the at least one electrode is configured to affect the wettability of a corresponding surface.

10. The apparatus of claim 1 further comprising:
a first material deposited in a portion of the channel, wherein the first material substantially prevents at least one of evaporation of the fluidic component of the microswitch, and contamination of the fluidic component of the microswitch.

11. A method comprising:
providing a substantially enclosed microswitch cavity;
transporting a fluidic component of a microswitch along a channel coupled to the substantially enclosed microswitch cavity.

12. The method of claim 11 further comprising:
depositing the fluidic component of the microswitch into a first reservoir; and
transporting the fluidic component of the microswitch from the first reservoir to a second reservoir coupled to the channel.

13. The method of claim 11 wherein the transporting further comprises at least one of:
evacuating at least a portion of the substantially enclosed microswitch cavity;
applying a pressure gradient between a portion of the channel and a portion of a vent coupled to the substantially enclosed microswitch cavity; and
increasing the wettability of a surface in contact with the fluidic component via an electrowetting effect.

14. The method of claim 11 wherein the fluidic component of the microswitch further comprises at least one of an electrically conductive fluid, a liquid metal, and a liquid metal alloy.

15. The method of claim 11 further comprising:
detecting the presence of the fluidic component in a reservoir using an electrical signal from at least one electrode in electrical contact with the fluidic component.

16. The method of claim 11 further comprising:
depositing a plug material into a portion of the channel.

17. The method of claim 11 wherein the providing the substantially enclosed microswitch cavity further comprises:
etching at least one of a first substrate and a second substrate, and bonding the first substrate to the second substrate.

18. An apparatus comprising:
a means for containing a fluid for use in a means for switching; and
a means for transporting the fluid from a first means for supplying the fluid to the means for switching.

19. The apparatus of claim 18 further comprising at least one of:
a means for evacuating at least a portion of the means for containing the fluid;
a means for applying a pressure gradient between a portion of the means for transporting the fluid and a means for venting coupled to the means for containing the fluid; and
a means for increasing the wettability of a surface in contact with the fluid via an electrowetting effect.

20. The apparatus of claim 18 further comprising:
a means for storing sufficient fluid for a plurality of means for containing a fluid, wherein the means for storing is coupled to the means for transporting the fluid.
